(19) United States
(12) Patent Application Publication
(10) Pub. No.: US 2019/0272604 A1
(43) Pub. Date: Sep. 5, 2019

(54) SYSTEM FOR INTEGRALLY OPERATING AND MANAGING BEHAVIOR INFORMATION RELATING TO TRANSACTION OF ASSET AND VALUE OF RESIDENT OF HOUSE, AND METHOD FOR TRANSACTING SAME

(71) Applicant: C-Nergy City Co., Ltd., Seoul (KR)

(72) Inventors: Neul KIM, Seongnam-si (KR); Eiya KIM, Seongnam-si (KR)

(21) Appl. No.: 16/347,865

(22) PCT Filed: Nov. 8, 2017
(86) PCT No.: PCT/KR2017/012561

§ 371 Date: May 7, 2019

(30) Foreign Application Priority Data
Nov. 8, 2016 (KR) 10-2016-0147844

(51) Int. Cl. G06Q 50/16; G06Q 30/06; G06T 11/00

(52) U.S. Cl. CPC G06Q 50/163; G06T 11/001; G06Q 30/0613; G06Q 30/0643

(57) ABSTRACT

The present invention generally relates to an unified management system of transaction information of resident's personal asset and value and the method of transaction thereof and more particularly to a system that manages transactions (including sharing and trading) of residents' all assets and values (including ideas and skills) by linking households via digital network and the method of transacting such assets and values. According to an embodiment of the present invention, the unified management system of transaction information of resident's personal asset and value is characterized by linking resident information devices (dispersed database) together, which are used for member registration, via blockchain (a form of dispersal database) based digital network, managing logs of transaction information of residents' personal assets (including talents) and values (including ideas and skills) using a blockchain based “my homepage” or application server after the logs are chronologically logged (coded) into the resident logging system based on blockchain technology.

### TECHNICAL FIELD

The present invention generally relates to an unified management system of transaction information of resident's personal asset and value and the method of transaction thereof and more particularly to a system that manages transactions (including sharing and trading) of residents' all assets and values (including ideas and skills) by linking households via digital network and its method of transacting such assets and values.

### BACKGROUND ART

Our current residential environment encompasses a space with a house.

This also implies the space to be an isolated environment with a culture deep rooted in the space.

While new residential spaces, which share houses (i.e. apartments), have the most innovative efficiency of space utilization compared to prior residential spaces, individuals become isolated by the residential space the moment it becomes a means of wealth proliferation by integrating capital to the shared house.

The space enclosed by gray building blocks that force individuals to be isolated interfered with human interactions and created a problem of life in isolation.

On the other hand, utility services for shared houses, such as apartments, generally include online and offline services: management of heating, air conditioning, gas, electricity, firefighting, elevator, and building safety check-up; management of outer-wall, water tank, disinfection, landscape and tree planting, and environment cleaning; management of building safety, parking, and security; delivery of utility fee notices and announcements, handling of residents' complaints, and communication between the residents and administration; interest group meetings, and communication among residents; electronic commerce service among apartment units; and, unmanned security, parking courier, and automatic inspection services.

Listed under Korean Patent Laid-Open Publication No. 10-2007-0032526, the unified shared housing management system and the method is a provider of home-network service server, data communication service server, and financial institution server. Its services as a unified management server further include provision of a homepage module that manages home network of households within the shared housing, subscription/termination of information and communications, and administration fee information; a liaison for home network service provider; a liaison for data communication service provider; an accounting unit that calculates each household's utility fee in the shared housing; a database for saving calculated utility fee; an administration unit that drafts the bills for home network service and home network service usage; a billing unit that saves each service bill in the server and sends each bill out to each household as a client through each household's information device.

According to the preceding patent, residents of shared housings benefit shared security office services, home network service and management of data communication service, utility fee payment services, and online maintenance and utility services by logging into the unified management system server using their information devices.

While conventional preceding patent provided convenience for the share housing residents, it failed to free them from their isolated households and to create a community of us, in which we could create new values and share amongst each other.

### DETAILED DESCRIPTION OF THE INVENTION

### Objects of the Invention

Contrived to resolve stated problems, an object of the invention is to provide an unified management system of transaction information of resident's personal asset and value and the method of transaction thereof that unify many isolated strangers as a community, create and share new values through virtually engaging interactions, convert those values as societal values, and, ultimately, foster a community without a discrepancy between oneself and another by linking households via digital network and managing transactions (including sharing and trading) of residents' all assets and values (including ideas and skills).

### SUMMARY OF THE INVENTION

According to an embodiment of the present invention, an unified management system of transaction information of resident's personal asset and value includes:

linking resident information devices together, which are used for member registration, via blockchain based digital network,

managing logs of transaction information of the residents' personal assets and values using a blockchain based “my homepage” or application server after the logs are chronologically logged into resident logging system based on the blockchain technology, and

classifying the assets uploaded from the resident information device into the blockchain based “my homepage” or app server into a private asset that only one can use, a public asset that anyone can use, and a donating asset and color coding the assets in different colors.

The blockchain based “my homepage” or app server comprises a virtual value storage, where the worth of the assets are stored as virtual currency, and a virtual value exchange place, where the public assets are traded.

The blockchain based “my homepage” or app server classifies and evaluates the uploaded assets and displays price as initial price, current price, and usage price.

The blockchain based “my homepage” or app server sets 1/100 of the current price as the usage price when using the public assets, receives payment from the public asset using resident in virtual currency, and deposits 1/10 of the usage price into the public asset using resident.

The blockchain based “my homepage” or app server calculates newly created values for each category of utility on settling days, equally distributes half of the calculated values among all participants, and distribute the other half of the calculated values according to individuals' contributions among all participants.

A method of resident's asset and value transaction comprises:

a step of a resident registering into blockchain based “my homepage” or app server, which is linked by blockchain based digital network, using resident information device;

a step of the resident uploading an image, video, or value into the blockchain based “my homepage” or app server from the resident information device and classifying and color coding assets as private asset, public asset, and donating asset;

a step of categorizing and price assessing the uploaded assets from the blockchain based “my homepage” or app server and classifying price as initial price, current price, or usage price;

a step of searching and selecting desired asset in the blockchain based “my homepage” or app server from the public asset user's resident information device and the public asset using resident paying the usage price with virtual currency; and

a step of the blockchain based “my homepage” or app server calculating the newly created values for each category of utility on settling days, equally distributing half of the calculated values among all participants, and distributing the other half of the calculated values according to individuals' contributions among all participants.

### Effects of the Invention

According to the present invention, linking households via digital network and trading, sharing, producing, and saving the assets and values among residents by jointly managing the transaction (including sharing and trading) information of all assets and values (including ideas and skills) will unify many isolated strangers as a community, create and share new values through virtually engaging interactions, convert those values as societal values, and foster a community without a discrepancy between oneself and another.

### BRIEF DESCRIPTION OF THE DRAWINGS

FIG. 1 is a conceptual diagram of the digital network that applies to the invention.

FIG. 2 is a diagram used to explain the resident logging system that applies to the invention.

FIG. 3 is a schematic diagram of the unified management system according to the embodiment of the invention.

FIG. 4 is a flowchart that depicts an example of a trade transaction according to the embodiment of the invention.

### PREFERRED EMBODIMENTS OF THE INVENTION

The following describes preferred embodiments of the present invention referring to attached figures.

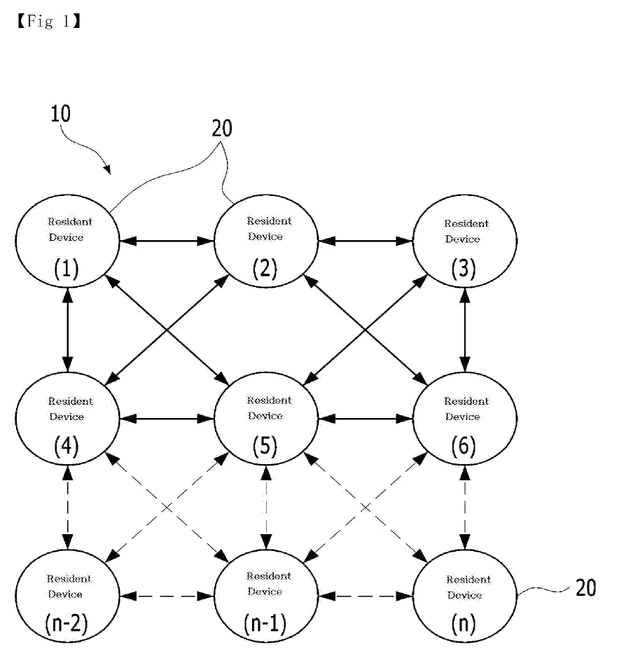

FIG. 1 is a conceptual diagram of the digital network that applies to the invention.

The present invention links resident devices (20) of a shared housing or individual households via digital network (10) and, based on blockchain, logs residents' unique ID, other identification ID, assigned asset code, and synergy forest's all trading procedure and step-wise code during a trade transaction.

Here, transactions, such as asset management, finance, entrepreneurship, entertainment, knowledge and education, garment, fashion, health and medicine, transportation, food, communication, and electronic game, of all assets and values (including ideas and skills) all refer to the synergy forest.

Here, blockchain is a form of dispersal database and cannot be fabricated by the manager of dispersal node as it is a continuously developing list of recorded data.

Because of the digital network (10) composed according to the stated blockchain technology, residents can mutually check and share residents' transaction and value information.

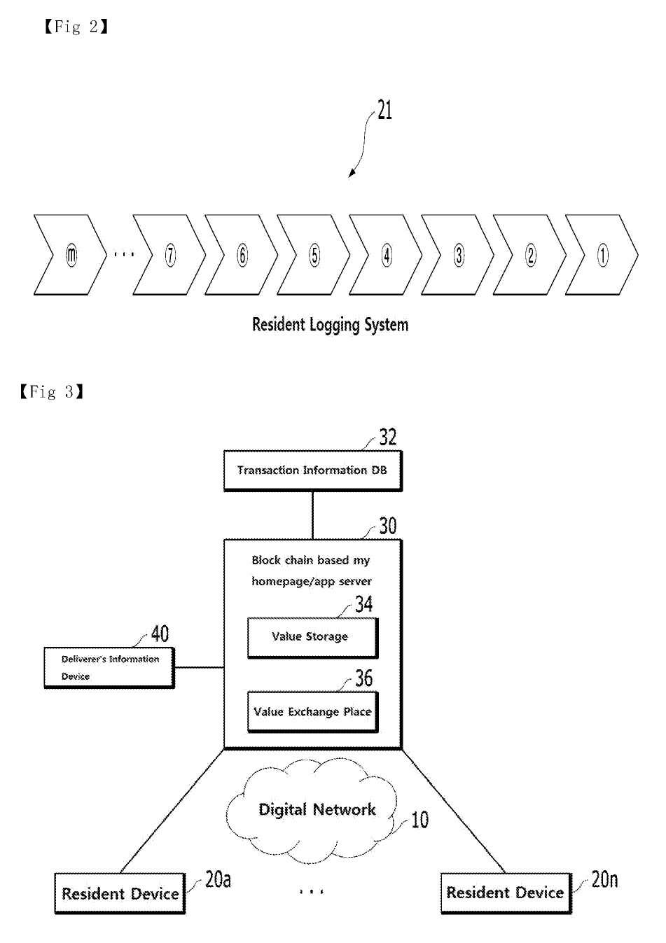

FIG. 2 is a diagram used to explain the resident logging system that applies to the invention.

As described in FIG. 2, the resident logging system (21) chronologically saves data (code) at the end of the log as transactions of residents' assets and values progress, similar to a car of a train being attached at the end of the train.

For example, the resident logging system (21) shown in FIG. 2 chronologically stores data: resident ID data in the first car (\textcircled{1}), living and main activity space code data in the second car (\textcircled{2}), Asset Management System (AMS) code data in the third car (\textcircled{3}), finance and value storage/management data in the fourth car (\textcircled{4}), record of labor time and new value created (including contribution) data in the fifth car (\textcircled{5}), transaction and payment data in the sixth car (\textcircled{6}), information assortment data in the seventh car (\textcircled{7}) . . . , and function and extension that can recognize and accommodate other information in the car (\textcircled{m}).

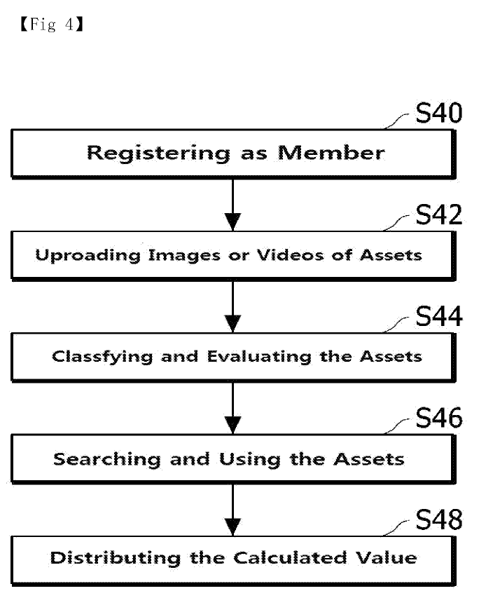

FIG. 3 is schematic diagram of the unified management system according to the embodiment of the invention.

As demonstrated in FIG. 3, multiple resident information devices registered as members (Nutorian) in the system are linked via blockchain based digital network (10), as shown in FIG. 1, and logs of the synergy forest information logged (coded) in the resident logging system (21) of FIG. 2 are jointly managed and operated in the blockchain based “my homepage” or app server (30).

For such purpose, the stated blockchain based “my homepage” or app server (30) operates and manages transaction information DB (32) and internally includes a value storage (34), where the worth of assets (including talents) are stored as virtual currency, and a virtual value exchange place (36), where public assets are traded.

Further, for pickup and delivery of goods, the resident deliverer's information device (40) is connected in the blockchain based “my homepage” and app server (30) via digital network (10).

In the united management system, residents register as members (Nutorian) using the resident information device into the blockchain based “my homepage” or app server (30).

After registering as a member, one uploads information, such as one's good or talent (giving haircuts, cleaning, teaching English, and etc.), images of goods, and etc. using the resident information device (20).

The stated blockchain based “my homepage” or app server (30) evaluates the worth of the uploaded good or talent, pays in virtual currency (Nuto-coin), and deposits into the above-mentioned value storage (34).

If the item uploaded in the stated “my homepage” or app server (30) is a good, one requests a pick-up service from one's resident information device (20) to the resident deliverer's information device (40), and the resident deliverer visits the resident who uploaded the good and picks it up.

While such transaction occurs, another resident can search for information about uploaded goods or talents from the virtual value exchange place (36) in the blockchain based “my homepage” or app server (30) using the resident information device (20), request for a good or talent, pay in virtual currency (Nuto-coin), and reserve a date when the good or talent is needed.

If the reserved item is a good, the blockchain based “my homepage” or app server (30) requests for a delivery on the reserved date to the resident deliverer's information device (40), and the deliverer delivers the good to the user who ordered the good.

Further, if the reserved item is a talent, the blockchain based “my homepage” or app server (30) negotiates the date with the talent providing resident via phone call or SMS through the resident information device (20) and informs the talent receiving resident about the date via call or SMS through the resident information device (20).

When the compromised date comes, the talent providing resident visits the talent receiving resident and provides the talent (giving a hair cute for example).

FIG. 4 is flowchart that depicts an example of a trade transaction according to the embodiment of the invention.

First, the resident receives an ID and confirms after registering as a member (Nutorian) of the blockchain based “my homepage” or app server (30) using the resident information device (20) (S40).

Next, the resident uploads images or videos of the resident's own assets into the blockchain based “my homepage” or app server (30) using the resident information device (20) (S42).

When uploading the assets, the resident can classify the asset as a private asset (PI(n)) that only the uploading resident uses, a public asset (PU(n)) that any resident can use by renting or purchasing, and a donating asset and color code in different colors (such is possible because it is a blockchain).

For example, the resident may code private asset (PI(n)) as blue and public asset (PU(n)) as orange.

The PU(n) may be used by any resident who is registered as a member from the virtual value exchange place (36).

When uploading an asset, the resident can upload one's talents (giving haircuts, cleaning, teaching English, and etc.) or ideas.

Next, the blockchain based “my homepage” or app server (30) classifies the asset that the resident uploaded and evaluates it for a price (S44).

Thus, the blockchain based “my homepage” or app server (30) specify the asset (garment, fashion, bedding, tools, books, entertainment, kitchen utensils, toys, and etc.) using the matching technique based on an asset assortment system, select the price based on the evaluation of the asset, and display.

At this time, the blockchain based “my homepage” or app server (30) display asset's price as total price, current price, and usage price (e.g. set the usage price as 1% of the current price), and the resident who uses the asset pays the usage price in virtual currency (Nuto-coin).

Then, the resident who uses the asset pay the resident who uploads the assets for the total value of assets (goods and ideas) in virtual currency.

The amount is saved in the value storage (34).

The resident who uses the asset do not pay virtual currency in case of donation.

Here, the resident uploads its own idea into the blockchain based “my homepage” or app server (30), and the value assessment committee evaluates the idea and decides the value.

For all the values of assets that residents use for their lives, the blockchain based “my homepage” or app server (30) calculate the newly created value for each category of utility. Then, it equally distribute 50% of the calculated value for each category of utility among all participants and distribute the other 50% of the calculated value according to individuals' contributions among all the participants.

Next, a resident, who desires to use (rent) a public asset (e.g. a golf club) uploaded in the blockchain based “my homepage” or app server (30), can search and select the desired public asset from the virtual value exchange place (36) using the resident information device (20), pay the usage price in virtual currency, which is then deposited into the value storage (34), and later use the public asset on the reserved date (S46).

At this time, the blockchain based “my homepage” or app server (30) may deposit t 10% of paid usage price with the resident paying the price and may exchange the deposited virtual currency from the value storage (34) into cash or use the virtual currency to pay for a public asset use later on.

Lastly, the blockchain based “my homepage” or app server (30) calculate all the values of each category of utility including all the usage prices that all the residents, who used public assets, paid for on settling days. Then, based on Revenue sharing system (RSS), equally distribute the half of the calculated value among participants and distribute the other half of the calculated value according to individuals' contributions among all participants (S48).

1. An unified management system of transaction information of resident's personal asset and value including:
linking resident information devices together, which are used for member registration, via blockchain based digital network,
managing logs of transaction information of the residents' personal assets and values using a blockchain based “my homepage” or application server after the logs are chronologically logged into resident logging system based on the blockchain technology, and
classifying the assets uploaded from the resident information device into the blockchain based “my homepage” or app server into a private asset that only one can use, a public asset that anyone can use, and a donating asset and color coding the assets in different colors.

2. The unified management system of transaction information resident's personal asset and value of claim 1, wherein the blockchain based “my homepage” or app server comprises a virtual value storage, where the worth of the assets are stored as virtual currency, and a virtual value exchange place, where the public assets are traded.

3. The unified management system of transaction information of resident's personal asset and value of claim 1, wherein the blockchain based “my homepage” or app server classifies and evaluates the uploaded assets and displays price as initial price, current price, and usage price.

4. The unified management system of transaction information of resident's personal asset and value of claim 3, wherein the blockchain based “my homepage” or app server sets 1/100 of the current price as the usage price when using the public assets, receives payment from the public asset using resident in virtual currency, and deposits 1/10 of the usage price into the public asset using resident.

5. The unified management system of transaction information resident's personal asset and value of claim 1, wherein the blockchain based “my homepage” or app server calculates newly created values for each category of utility on settling days, equally distributes half of the calculated values among all participants, and distribute the other half of the calculated values according to individuals' contributions among all participants.

6. A method of resident's asset and value transaction comprising:
a step of a resident registering into blockchain based “my homepage” or app server, which is linked by blockchain based digital network, using resident information device;
a step of the resident uploading an image, video, or value into the blockchain based “my homepage” or app server from the resident information device and classifying and color coding assets as private asset, public asset, and donating asset;
a step of categorizing and price assessing the uploaded assets from the blockchain based “my homepage” or app server and classifying price as initial price, current price, or usage price;
a step of searching and selecting desired asset in the blockchain based “my homepage” or app server from the public asset user's resident information device and the public asset using resident paying the usage price with virtual currency; and
a step of the blockchain based “my homepage” or app server calculating the newly created values for each category of utility on settling days, equally distributing half of the calculated values among all participants, and distributing the other half of the calculated values according to individuals' contributions among all participants.
